(19) United States
(12) Patent Application Publication
(10) Pub. No.: US 2002/0009195 A1
(43) Pub. Date: Jan. 24, 2002

(54) Holder for mobile telephones

(75) Inventor: Lennart Schon, Enskede (SE)

Correspondence Address: NIXON & VANDERHYE P.C., 1100 North Glebe Road, 8th Floor, Arlington, VA, 22201-4714, US

(73) Assignee: Telefonaktiebolaget LM Ericsson

(21) Appl. No.: 09/951,561

(22) Filed: Sep. 14, 2001

Related U.S. Application Data
(63) Continuation of application No. 09/427,039, filed on Oct. 26, 1999, now abandoned.

(51) Int. Cl. H04M 1/00

(52) U.S. Cl. 379/454

(57) ABSTRACT

A holder for a mobile telephone, which has a loudspeaker placed on for example its rear side, comprises a sound conducting horn—structure having an inlet and a funnel-shaped outlet. The horn structure conducts sound along a curved path and comprises a sound conducting conduit or a sound conducting channel of type acoustic horn for amplifying the sound. The holder can thereby efficiently use the loudspeaker of the mobile telephone to issue sound in a room, for example in a car, in which the holder and the mobile telephone placed therein are located.

The invention relates to a holder for a mobile telephone which can be rigidly attached to for example a vehicle.

### BACKGROUND

Mobile telephones are used more and more and they are often placed in holders, such as in vehicles, located at some distance from the person using the telephone. Then it can be difficult to hear the sound which is emitted from the telephone, even though the telephone has a loudspeaker at its front side. In addition some mobile telephones have a large loudspeaker at their rear sides, i.e. the side which is opposite the side, the front side, where display, microphone and a set of keys are placed. When such a mobile telephone is placed in a holder in which normally the front side of the mobile telephone is visible, such a large rear loudspeaker can apparently not be used to obtain sound which can be easily heard at some distance of the mobile telephone.

Sound conducting structures have been proposed for conventional telephone sets comprising an apparatus set and a separate handset, see West German Offenlegungschrift 24 40 511. The apparatus set is provided with a weakly concave portion located directly beneath the telephone receiver of the handset to redirect the sound from the loudspeaker. In U.S. Pat. No. 2,987,575 a similar construction is disclosed having instead a sound amplifying and conducting structure for conducting sound to the mouthpiece of the transmitter of the handset. In West German Offenlegungschrift 27 52 556 a device is disclosed for a conventional handset allowing a second person to also hear what is received by a telephone set. This prior device has a connection sleeve to be attached to the receiver of the handset and a flexible hose connecting the sleeve to a horn. A somewhat similar construction is disclosed in U.S. Pat. No. 5,703,946 comprising a holder for a mobile telephone, the holder including a connection device 30 to be located at the speaker of the telephone and a flexible hose conducting sound from the connection device to an ear plug.

### SUMMARY

It is an object of the invention to provide a holder for a mobile telephone which can efficiently utilize a loudspeaker of the mobile telephone, which loudspeaker is for example placed on the rear side of the mobile telephone, in order to issue sound in a room, for example inside a vehicle such as a motor car, in which the holder and the mobile telephone placed therein are located.

The problem which the invention intends to solve is thus to provide a good reproduction of sound for sound issued by mobile telephones which are placed in holders.

Thus, in a holder adapted to receive a mobile telephone a sound conducting horn structure is used which conducts sound along a long curved path from the opening of the loudspeaker of a mobile telephone placed in the holder up to the opening of a horn which is placed at some distance of the opening of the loudspeaker. The horn structure comprises a sound conducting pipe or sound conducting channel having a funnel shaped opening, the sound conducting structure and the funnel or horn being parts integrated in the holder. The sound thus passes through a pipe or conduit having walls enclosing the sound path. The path of the sound has in the preferred case a length which at least corresponds to the thickness or preferably the width of a mobile telephone together with which the holder is intended to be used. The horn structure can be designed to amplify the conducted sound by having its cross sectional area successively increase along the path of the sound up to the opening of the horn.

In the cited telephone set disclosed in West German Offenlegungschrift 24 40 511 no sound conducting horn structure is provided and it has no sound conducting pipe or conduit.

Additional objects and advantages of the invention will be set forth in the description which follows, and in part will be obvious from the description, or may be learned by practice of the invention. The objects and advantages of the invention may be realized and obtained by means of the methods, processes, instrumentalities and combinations particularly pointed out in the appended claims.

### BRIEF DESCRIPTION OF THE DRAWINGS

While the novel features of the invention are set forth with particularly in the appended claims, a complete understanding of the invention, both as to organization and content, and of the above and other features thereof may be gained from and the invention will be better appreciated from a consideration of the following detailed description of non-limiting embodiments presented hereinbelow with reference to the accompanying drawings, in which:

FIG. 1 is a perspective view of a mobile telephone holder having a mobile telephone placed at the side of the holder, the view being seen obliquely from the side and from the front and bottom of the holder,

FIG. 2 is a perspective view similar to that of FIG. 1 but having the mobile telephone placed in the holder, and

FIG. 3 is a view of the holder as seen from the rear side thereof.

### DETAILED DESCRIPTION

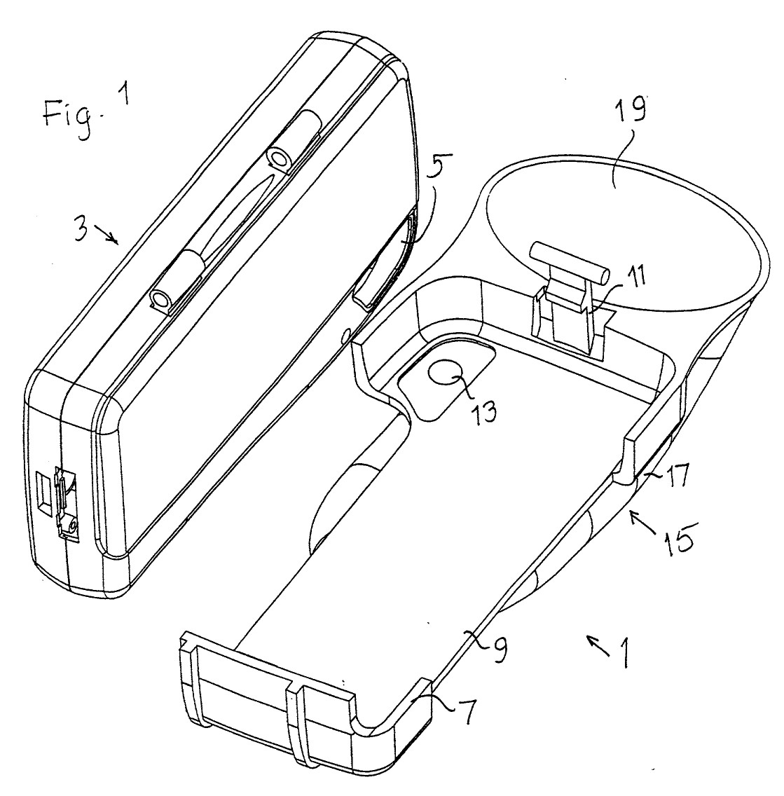

In FIG. 1 a holder 1 for a mobile telephone 3 is shown. The mobile telephone has a large loudspeaker 5 at its rear side, close to an upper corner thereof. The holder 1 has a front side comprising marginal portions 7, which project from a base plate 9, in order to receive the mobile telephone 3 between the marginal portions 7 and locate it in a definite position. At the upper marginal portion of the holder 1 a snap lock 11 is provided to rigidly retain the mobile telephone 3.

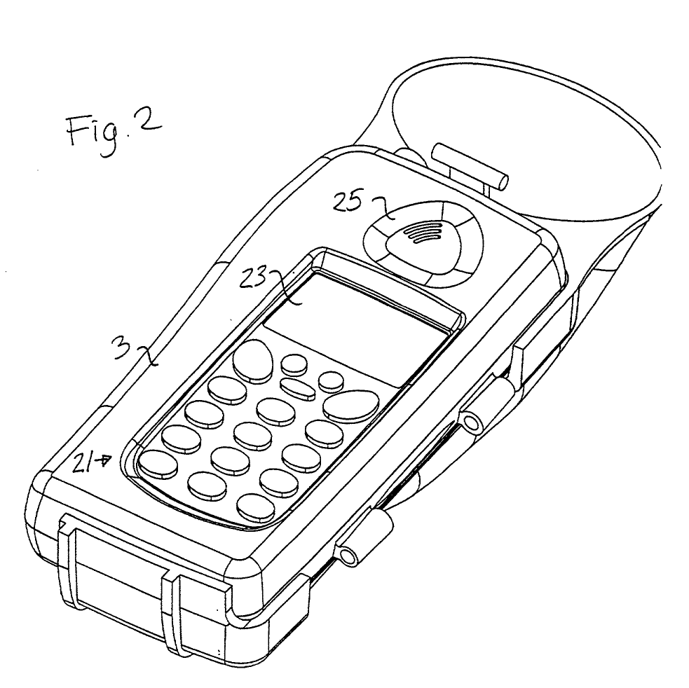

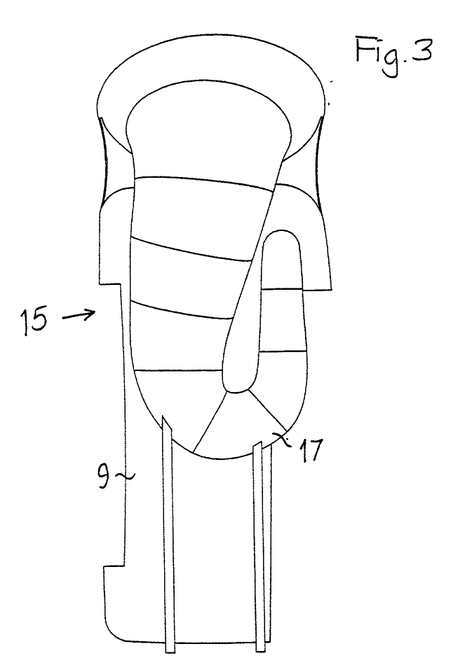

In the base plate 9 an inlet 13 of a horn device 15 is provided, see also FIG. 3. The horn device 15 is the type acoustic horn and thus acts amplifying on sound waves which propagate therein. It comprises a pipeline or conduit 17 which expands more and more, first weakly and thereupon with a larger pitch in order to finally mouth in a wide funnel or outlet horn 19. The funnel 19 has its opening directed towards the front side of the holder 1 and is placed at the upper short side of the holder 1, close to the upper marginal portion and the snap lock 11. The front edge of the funnel 19 is located in the same plane as the front-most surfaces or upper surfaces of the marginal portions. Furthermore, the opening of the funnel 19 has an elliptically compressed shape as seen from the front side of the holder 1 having its large axis located parallel to the adjacent upper edge portion. The length of the large axis of or the width of the funnel laterally is approximately equal to the total width of the mobile telephone 3, see also FIG. 2, and to the width of the holder 1. The length of the small axis of the elliptical shape can be smaller, for example between 50 and 90% of the length of the large axis. The inlet 13 of the horn device 15 is located so that it is positioned opposite the loudspeaker 5 when the mobile telephone 3 is placed in the holder 1.

The conduit portion 17 of the horn device 15, see FIG. 3, is with one generatrix substantially located in a plane which extends close to the rear side of the base plate 9, so that the conduit portion over a large portion of its length is attached to the rear side of the base plate. The conduit portion 17 extends firstly towards the rear side, then forms a straight angle to extend downwards in parallel to the longitudinal direction of the holder 1, then forms a bend of an angle of about 180° approximately at the center of the base plate 9, so that it after the bend again extends approximately in the longitudinal direction of the holder 1 but now upwards therealong. Finally the conduit portion 17 makes a bend of approximately 90° in order to mouth in the funnel 19.

In FIG. 2 the mobile telephone 3 is shown as placed in the holder 1. The front side of the mobile telephone 3 is then completely available and here a set 21 of keys, a display 23 and a microphone 25 are provided. When receiving telephone calls then the rear loudspeaker 5 can be activated and the sound emitted thereby passes through the horn device to the amplified and is issued in the room in which the holder 1 is placed.

For mobile telephones having a loudspeaker opening at their front side a holder having a corresponding horn structure can be used in order to improve the emission of sound by the telephone.

While specific embodiments of the invention have been illustrated and described herein, it is realized that numerous additional advantages, modifications and changes will readily occur to those skilled in the art. Therefore, the invention in its broader aspects is not limited to the specific details, representative devices and illustrated examples shown and described herein. Accordingly, various modifications may be made without departing from the spirit or scope of the general inventive concept as defined by the appended claims and their equivalents. It is therefore to be understood that the appended claims are intended to cover all such modifications and changes as fall within a true spirit and scope of the invention.

What is claimed is:

1. A holder for a mobile telephone, the holder comprising a sound conducting horn device having a sound inlet and a sound outlet and a conduit therebetween, the sound inlet being located to receive sound emitted from a loudspeaker of a mobile telephone placed in the holder and the horn device amplifying sound received by the sound inlet and propagating from the sound inlet of the horn device to the sound outlet to be emitted from the sound outlet into a room in which the holder is placed.

2. The holder of claim 1, wherein the horn device is arranged to conduct sound along a path which has a length corresponding to at least the thickness of or preferably at least the width of a mobile telephone placed in the holder.

3. The holder of claim 1, wherein the horn device is type acoustic horn, the conduit having an inner diameter which increases when passing from the sound inlet to the sound outlet.

4. The holder of claim 1, wherein the sound outlet is designed as an outlet horn or funnel having an opening which is directed to a front side of the holder.

5. The holder of claim 1 further comprising a base plate having a front surface and a rear opposite surface, a mobile telephone when it is placed in the holder resting at the front surface and the conduit over at least a major portion of its length extending along a path located at the rear surface.

6. The holder of claim 5, wherein the conduit along its path forms a bend of substantially 180°.

7. The holder of claim 1 further comprising a base plate having a front surface and a rear opposite surface, a mobile telephone when it is placed in the holder resting at the front surface and the sound inlet being located in the front surface.

8. The holder of claim 1 further comprising a base plate, at which a mobile telephone rests when it is placed in the holder, the base plate having a substantially rectangular shape including short opposite sides and long opposite sides, the sound outlet being located at and/or being connected to one of the short sides.
